(19) United States
(12) Patent Application Publication
(10) Pub. No.: US 2023/0264335 A1
(43) Pub. Date: Aug. 24, 2023

(54) Portable Work Apparatus

(71) Applicant: Andreas Stihl AG & Co. KG, Waiblingen (DE)

(72) Inventors: David Klett, Ludwigsburg (DE); Heiko Diehl, Esslingen (DE); Sebastian Junker, Ludwigsburg (DE)

(73) Assignee: Andreas Stihl AG & Co. KG, Waiblingen (DE)

(21) Appl. No.: 18/170,911

(22) Filed: Feb. 17, 2023

(30) Foreign Application Priority Data
Feb. 21, 2022 (EP) 22157844.6

(51) Int. Cl. B25F 5/00; F16C 19/14; F16C 19/54

(52) U.S. Cl. CPC B25F 5/001; F16C 19/14; F16C 19/54

(57) ABSTRACT

A portable work apparatus comprises a housing (2) and a tool (9). A drive motor (5) is arranged in the housing (2) between the first end (3) and the second end (4) and has a drive shaft (7) for driving the tool (9). The drive motor (5) has a first bearing (12) and a second bearing (13). The drive shaft (7) is rotatably (11) supported relative to the housing (2) by means of the first bearing (12) and the second bearing (13). A drive transmission unit (8) is functionally arranged between the drive motor (5) and the tool (9). The work apparatus (1) has additional bearing (14) for supporting the drive shaft (7) relative to the housing (2) of the work apparatus (1) arranged on the drive shaft (7).

### CROSS-REFERENCE TO RELATED APPLICATION

This application claims the benefit of European Patent Application No. 22157844.6, filed 2022 Feb. 21, the contents of which are incorporated by reference in their entireties.

### TECHNICAL FIELD

The disclosure relates to a portable work apparatus and more specifically to a power tool.

### BACKGROUND

Portable work apparatuses are known which have a housing, a drive motor arranged in the housing and a tool driven by the drive motor. The drive motor is designed as an electric motor, in particular as a DC motor. Such DC motors can be used in many different ways and are commercially available as mass-produced items. Such a DC motor has a motor housing and a drive shaft which is mounted on the motor housing via a bearing arrangement and which extends out of the motor housing. The drive shaft is also designed as the rotor of the electric motor. Such DC motors are usually designed as inrunners, the windings of the rotor are connected via a commutator. Sliding contacts, which can be in the form of metal or carbon brushes, rest against the commutator.

It has been shown with such work apparatuses that damage to the drive motor can occur even with short operating times of the work apparatus, as a result of which operation of the work apparatus is restricted or no longer possible.

### SUMMARY

An object of the disclosure is to specify a portable work apparatus that allows a long service life. The object is achieved by a portable work apparatus with the features as claimed.

The invention is based on the observation that, in the case of portable work apparatuses known from the prior art, increased sparking occur between the brushes and the commutator during operation. The intensity of the sparking depends on the load of the work apparatus. The drive shaft is subject to flexural vibrations during operation of the work apparatus so that the position of the sliding contacts relative to the commutator constantly changes and there is an increase in sparking. The invention is now based on the finding that mounting the drive shaft with as little vibration as possible enables a uniform contact between the sliding contacts and the commutator and thereby reduces sparking.

An improved portable work apparatus comprises a housing and a tool. The housing extends from a first end to a second end. A drive motor is arranged in the housing between the first end and the second end and has a drive shaft for driving the tool. The drive motor has a first bearing and a second bearing. The drive shaft is rotatably mounted relative to the housing by means of the first bearing and the second bearing. A drive transmission unit is functionally arranged between the drive motor and the tool. The work apparatus comprises an additional bearing mounted on the drive shaft to support the drive shaft against the housing of the work apparatus.

By using the additional bearing, the bearing arrangement of the drive shaft is stiffened. Loads are absorbed by the additional bearing. The flexural vibrations of the drive shaft are reduced or even completely avoided by the additional bearing. In other words, the vibration amplitudes of the flexural vibrations are reduced by the additional bearing. As a result, the drive shaft rotates with increased concentricity, resulting in even contact between the sliding contacts and the commutator. The sparking is reduced, which increases the service life of the drive motor.

In addition, the additional bearing is also of particular advantage in other drive motors, such as brushless electric motors or combustion engines, since the reduction in flexural vibrations can prevent damage to bearings of the drive shaft, to motor mounts, and to the gearing.

The additional bearing is preferably designed as a floating bearing. The motor's own bearing arrangement is preferably designed as a locating/non-locating bearing arrangement. By designing the additional bearing as a floating bearing, an overdetermination of the bearing arrangement of the drive shaft and the resulting distortions can be avoided. The additional bearing is in particular designed as a radial bearing. The additional bearing is preferably a ball bearing. As a result, in addition to the radial forces, axial forces acting on the drive shaft in the direction of the axis of rotation can also be absorbed.

It is advantageously provided that the drive motor is fastened to the housing in such a way that the drive motor is firmly connected to the housing in the direction of its axis of rotation. The drive motor is preferably attached to the housing via an attachment unit. The outer ring of the additional bearing is preferably in direct contact with the attachment unit. It is advantageously provided that a pinion is co-rotatingly held on the drive shaft of the drive motor, the pinion being part of the drive transmission unit. The additional bearing preferably rests with its inner ring on a receiving section of the pinion. As a result, the forces acting on the pinion, in particular radial forces, are transferred directly into the attachment unit via the additional bearing.

It was also observed that resonance vibrations can occur on the drive shaft in the area of the additional bearing. The cause of the resonance vibrations is a so-called knocking, which means that the balls of the additional bearing generate a deformation of the bearing rings when passing through the load range, which in turn leads to resonance vibrations in the drive shaft. In order to avoid deformation of the bearing rings and the associated resonance vibrations, the additional bearing must be dimensioned in such a way that the bearing rings are no longer deformed. Therefore, an outer diameter of the outer ring of the additional bearing is preferably at least as large as the maximum outer diameter of the pinion.

Provision is advantageously made for the drive transmission unit to be in the form of a gearing which is free of axial forces. Accordingly, the drive transmission unit is designed in such a way that no axial forces act on the drive shaft in the direction of the axis of rotation of the drive motor. In that case a radial bearing arrangement of the drive shaft is not necessary. The pinion is advantageously prestressed in the direction of the axis of rotation of the drive motor by means of a spring unit. The drive shaft is axially preloaded by using the spring unit, which counteracts manufacturing tolerances. This sets a targeted backlash in the drive transmission unit. Too large or too small backlash in the drive transmission unit can be avoided.

The drive transmission unit preferably has a gear ratio of 3. As a result, a drive motor rotating at high speed, in particular a brushed DC motor, can be used in the work apparatus with a speed adapted to the tool.

It is advantageously provided that the drive motor comprises a motor housing, the drive shaft being rotatably mounted directly within the motor housing by means of the first bearing and the second bearing.

Further features of the invention result from the following description and the exemplary embodiments illustrated in the drawing.

### BRIEF DESCRIPTION OF THE DRAWINGS

FIG. 1 is a perspective view of an embodiment of a portable work apparatus with a drive tube and a tool at one end and an energy source at the other end of the drive tube.

FIG. 2 shows the portable work apparatus in a side view with a schematically indicated drive tube.

FIG. 3 shows a top view of the portable work apparatus according to FIG. 2.

FIG. 4 shows a lateral cross-sectional view of the portable work apparatus according to FIG. 2.

FIG. 5 shows a cross-sectional top view of the portable work apparatus according to FIG. 2.

FIG. 6 shows the portable work apparatus according to FIG. 2 in a partial cross-sectional top view.

FIG. 7 shows an alternative embodiment of the work apparatus with a spring unit in a partial cross-sectional top view.

### DETAILED DESCRIPTION

In the figures the same components are marked with the same reference characters.

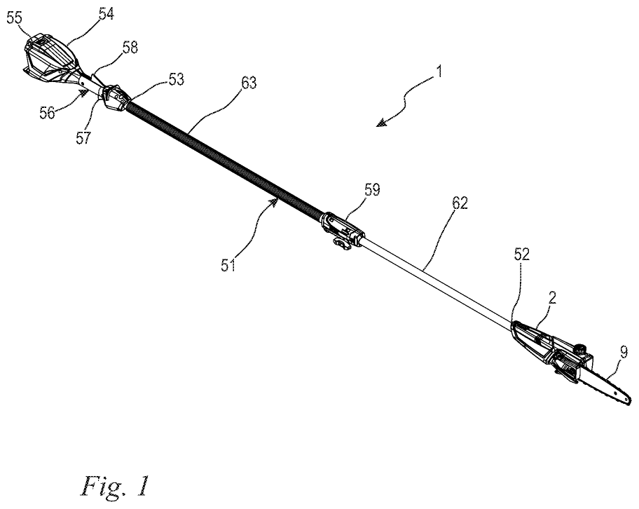

In FIG. 1, the portable work apparatus 1 is shown, which is designed as a motorized pole saw. The portable work apparatus 1 can also be designed as a motor chain saw, hedge trimmer, circular saw, or similar power tool. The portable work apparatus 1 comprises a housing 2, a drive motor 5 arranged in the housing 2, and a tool 9 which can be driven by the drive motor 5.

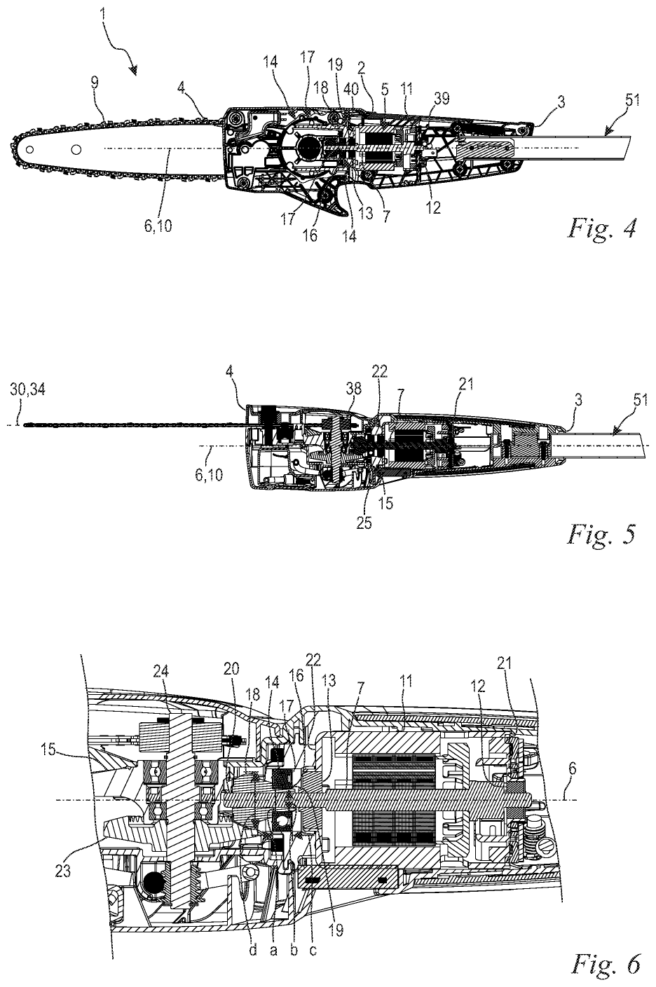

As shown in FIGS. 4 and 5, the drive motor 5 is designed as an electric motor. In the exemplary embodiment, the electric motor is designed as a DC motor, in particular as a brushed motor. Alternatively, the electric motor can also be designed as a brushless DC motor. In an alternative embodiment of the portable work apparatus, the drive motor can also be designed as an internal combustion engine.

As shown in FIG. 1, the portable work apparatus 1 comprises a drive tube 51 with a first end 52 and a second end 53. The housing 2 of the work apparatus 1 is held at the first end 52 of the drive tube. A second housing 54 is held at the second end 53 of the drive tube 51. The second housing 54 has a receiving slot 55 for receiving a rechargeable battery or a similar energy source. It can be expedient to use a stationary supply network as the energy source, which is connected to the second housing 54 or to control electronics arranged in the second housing 54 via an electrical line. In the illustrated exemplary embodiment, an operating handle 56 with operating elements is provided at the second end 53 of the drive tube 51. In the illustrated exemplary embodiment, an operating element referred to as an operating lever 57 or gas lever and a blocking lever 58 are provided as operating elements. The operating lever 57 is used to control the drive motor 5. The blocking lever 58 is provided to secure the operating lever 57.

As shown in FIG. 1, the drive tube 51 is preferably designed to be telescopic in the exemplary embodiment. The drive tube 51 comprises a first tube section 62 with the first end 52 of the drive tube 51 and a second tube section 63 with the second end 53 of the drive tube 51. The drive tube 51 includes a clamping device 59. The clamping device 59 is preferably attached to the second tube section 63. The clamping device 59 is used to fix the first tube section 62 to the second tube section 63. In an alternative embodiment, the drive tube 51 is not telescopic. In such an embodiment, the clamping device 59 serves to connect the first tube section 62 and the second tube section 63. Additional extension pieces can also be provided.

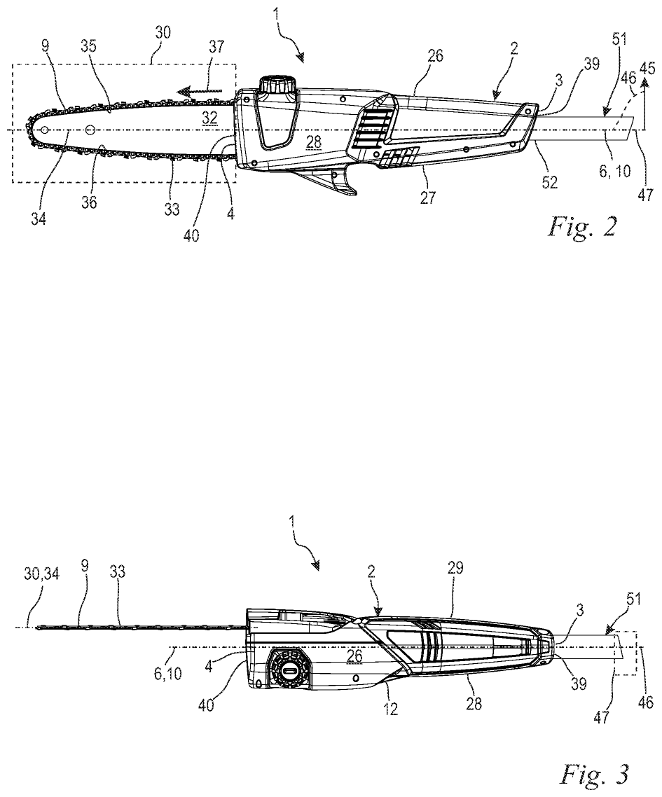

As shown in FIG. 2, the housing 2 of the portable work apparatus 1 extends in a longitudinal direction 10 from a rear end 3 to a front end 4. The tool 9 is arranged at the front end 4 of the housing. In the exemplary embodiment, the tool 9 is designed as chainsaw chain 33. The chainsaw chain 33 is driven to revolve around a guide bar 32 in a running direction 37 via a chain drive wheel 38 (FIG. 5). The running direction 37 of the chainsaw chain 33 is the direction of movement of the chainsaw chain 33 provided for the intended operation of the work apparatus 1 for chip removal. The chain drive wheel 38 is driven in rotation by the drive motor 5. The guide bar 32 is arranged at the front end 4 of the housing 2 and extends in a longitudinal direction 34 which corresponds to a direction from the rear end 3 to the front end 4 of the housing 2. The chainsaw chain 33 spans a tool plane 30, with both the chainsaw chain 33 and the guide bar 32 lying in the tool plane 30.

As shown in FIG. 2, the guide bar 32 has a top side 35 and a bottom side 36. When the portable work apparatus 1 is operated as intended, the chainsaw chain 33 runs on the top side 35 of the guide bar 32 in the direction away from the front end 4 of the housing 2. When the portable work apparatus 1 is operated as intended, the chainsaw chain 33 runs on the bottom side 35 of the guide bar 32 in the direction towards the front end 4 of the housing 2. Both the top side 35 of the guide bar 32 and the bottom side 36 of the guide bar 32 lie in the tool plane 30.

As shown in FIGS. 2 and 3, the housing 2 extends along its longitudinal direction 10 from its rear end 3 to its front end 4. The rear end 3 forms the first end face 39 of the housing 2. The front end 4 of the housing 2 forms the second end face 40 of the housing 2. The housing 2 comprises a top side 26 and a bottom side 27. In addition, the housing 2 comprises a first longitudinal side 28 and a second longitudinal side 29. The first end face 39 and the second end face 40 of the housing 2 are connected to one another via the top side 26, the bottom side 27, the first longitudinal side 28, and the second longitudinal side 29 of the housing 2. When the work apparatus 1 is operated as intended, the top side 26 of the housing 2 is above the bottom side 27 of the housing 2. A vertical direction 45 running from the bottom side 27 to the top side 26 spans a longitudinal plane 46 of the housing 2 together with the longitudinal direction 10 or with the axis of rotation 6 of the drive motor 5. The housing 2 comprises a transverse plane 47 which is aligned orthogonally to the longitudinal plane 46 and to the vertical direction 45. The longitudinal sides 28, 29 are arranged opposite one another with respect to the longitudinal plane 46. The top side 26 and the bottom side 27 are arranged opposite one another with respect to the transverse plane 47. In the exemplary embodiment, the longitudinal plane 46 of the housing 2 is aligned parallel to the plane 30 of the tool.

As shown in FIGS. 4 to 6, the drive motor 5 designed as an electric motor is arranged in the housing 2 between the rear end 3 of the housing 2 and the front end 4 of the housing 2. The drive motor 5 includes an axis of rotation 6 which corresponds to the longitudinal direction 10 of the housing 2 in the exemplary embodiment. The drive motor 5 includes a motor housing 11 which extends along the axis of rotation 6 of the drive motor 5 from a first end face 21 to a second end face 22 of the motor housing 11. The first end 21 of the motor housing 11 faces the rear end 3 of the housing 2. The second end 22 of the drive motor 5 faces the front end 4 of the housing 2.

As shown in FIGS. 4 to 6, the drive motor 5 comprises a drive shaft 7. The drive shaft 7 protrudes with a drive section 20 at the second end 22 of the motor housing 11 out of the motor housing 11 in the direction of the front end 4 of the housing 2. The drive motor 5 comprises a first bearing 12 and a second bearing 13. The drive shaft 7 is rotatably mounted on the motor housing 11 via the first bearing 12 and the second bearing 13. The first bearing 12 is arranged at the first end 21 of the motor housing 11. The second bearing 13 is arranged at the second end 22 of the motor housing 11. The first bearing 12 is designed as a floating bearing. The second bearing 13 is designed as a fixed bearing. The first bearing 12 and the second bearing 13 thus form a locating/non-locating bearing arrangement between the drive shaft 7 and the motor housing 11. The first bearing 12 and the second bearing 13 are indicated only schematically in FIGS. 4 to 6.

As shown in particular in FIG. 6, the portable work apparatus 1 has a drive transmission unit 8. The drive transmission unit 8 is designed to transmit the energy of the drive motor 5 to the tool 9 to be driven. In the present exemplary embodiment, the drive transmission unit 8 is designed as a gearing, since both the speed and the torque from the drive motor 5 to the tool 9 are converted. In the present exemplary embodiment, the drive transmission unit 8 comprises a pinion 18, a bevel gear 23 and the chain drive wheel 38. In an alternative configuration of the work apparatus 1, it can also be expedient to design the drive transmission unit 8 differently.

As shown in particular in FIG. 6, the pinion 18 is arranged on the drive section 20 of the drive shaft 7 in a co-rotating manner. The pinion 18 is held on the drive shaft 7 by a press fit. Alternatively, the pinion 18 can also be held co-rotatingly on the drive shaft 7 in a form-fitting manner, in particular via a tongue and groove connection. The pinion 18 is operatively connected to the bevel gear 23. The work apparatus 1 has an output shaft 24, the bevel gear 23 being held co-rotatingly on the output shaft 24. The output shaft 24 is rotatably mounted in the housing 2. The chain drive wheel 38 is co-rotatingly held on the output shaft 24. The pinion 18 arranged on the drive shaft 7 of the drive motor 5 drives the bevel gear 23. The output shaft 24 and thus also the chain drive wheel 38 are in turn driven via the bevel gear 23.

From the operative connection between the bevel gear 23 and the pinion 18, forces are transmitted via the pinion 18 to the drive shaft 7 during operation of the work apparatus 1. These forces can lead to flexural vibrations of the drive shaft 7. In order to counteract these flexural vibrations, the work apparatus 1 includes an additional bearing 14, as shown in FIGS. 4 to 6. The additional bearing 14 supports the drive shaft 7 at least indirectly against the housing 2. The additional bearing 14 is a radial bearing. The drive shaft 7 is thus supported in three points, as a result of which the amplitudes of the flexural vibrations of the drive shaft 7 are significantly reduced or can even be avoided entirely. This circumstance has an advantageous effect on the service life of the drive motor 5. The additional bearing 14 is designed as a ball bearing, as a result of which the additional bearing 14 can support not only radial forces but also axial forces, i.e., forces acting in the direction of the axis of rotation 6 against the housing 2. The pinion 18 has a receiving section 19. In the exemplary embodiment, the additional bearing 14 is arranged directly on the receiving section 19 of the pinion 18. Accordingly, the additional bearing 14 rests with its bearing inner ring 17 directly on the receiving section 19 of the pinion 18. The forces acting on the pinion 18 are thus transmitted directly to the additional bearing 14 in the housing 2. The flow of forces does not run via the drive shaft 7. In an alternative embodiment of the work apparatus 1, it can be expedient to arrange the additional bearing 14 directly on the drive shaft 7. It should be noted here that the arrangement of the additional bearing 14 is as close as possible to the introduction of force into the drive shaft 7 in order to be able to transmit the forces to the housing 2 under low bending loads on the drive shaft 7. Accordingly, in such an alternative embodiment, the additional bearing 14 is fastened adjacent to the pinion 18 directly on the drive section 20 of the drive shaft 7.

As shown in FIG. 6, the additional bearing 14 has an outer diameter a measured radially to the axis of rotation 6, an inner diameter b measured radially to the axis of rotation 6, and a bearing width c measured in the direction of the axis of rotation 6. The outer diameter a of the additional bearing 14 is at least as large as a maximum outer diameter d of the pinion 18. The outer diameter a of the additional bearing 14 is preferably larger than the outer diameter of the first bearing 12 and the second bearing 13. The outer diameter a of the additional bearing 14 is preferably at least 15 mm, preferably at least 20 mm, in particular approximately 22 mm. The inner diameter b of the additional bearing 14 is preferably at least 5 mm, in particular at least 7, preferably around 8 mm. The width c of the additional bearing 14 is preferably at least 5 mm, in particular at least 6 mm, preferably around 7 mm.

The force to be transmitted from the pinion 18 to the bevel gear 23 is to be supported on the housing 2 via the additional bearing 14. If the work apparatus 1 is in operation, the drive shaft 7 rotates, with the balls of the additional bearing 14 repeatedly, i.e., at a ball passing frequency, passing through an area of maximum force transmission in the additional bearing 14. Deformations of the inner bearing ring 17 and/or the outer bearing ring 16 can occur in the area of maximum force transmission, and thus also cause a deformation of the drive shaft 7. If the ball passing frequency corresponds to an excitation frequency of the drive shaft 7 or of the entire drive motor 5, the drive motor 5 can be damaged. The above-described oversizing of the additional bearing 14 means that the bearing outer ring 16 and the bearing inner ring 17 of the additional bearing 14 no longer deform and consequently also no longer noticeably act on the drive shaft 7 with the ball passing frequency.

As shown in FIGS. 4 to 6, the work apparatus 1 comprises an attachment unit 15. The attachment unit 15 is designed to fasten the drive motor 5 to the housing 2. The drive motor 5, in particular the motor housing 11 of the drive motor 5, is preferably attached directly to the attachment unit 15. In the exemplary embodiment, the drive motor 5 is screwed to the attachment unit 15 by a plurality of screws 25, in particular by four screws 25. In an alternative embodiment of the portable work apparatus 1, it can be expedient to also provide a different number of screws 25 in order to fasten the drive motor 5 to the attachment unit 15. In the preferred exemplary embodiment, the attachment unit 15 is connected to the housing 2 of the work apparatus 1 via anti-vibration elements, which are not shown in detail. In an alternative embodiment of the work apparatus 1, the attachment unit 15 can also be attached directly to the housing 2 of the work apparatus 1. The attachment unit 15 is preferably formed of a metal plate. The metal plate is preferably formed from a magnesium alloy, or from an aluminum alloy. The additional bearing 14 contacts the attachment unit 15 with its outer ring 16. In the exemplary embodiment, the additional bearing 14 is designed as a floating bearing in order to avoid tension between the drive motor 5 and the attachment unit 15. Since the motor housing 11 is firmly screwed to the attachment unit 15, designing the additional bearing 14 as a fixed bearing would result in the system being overdetermined and, if the drive shaft 7 were to expand during operation of the work apparatus 1, the system would be distorted and the drive motor 5 might even be damaged.

As shown in FIGS. 4 to 6, the bevel gear 23 and the pinion 18 are in engagement. In the case of such bevel gears, high axial forces usually arise, which act on the drive pinion in the direction of the drive shaft. Such axial forces are to be supported by appropriate radial bearings or adjusted bearing arrangements. The drive motor 5 used in the present embodiment is a simple commercially available brushed DC motor. Such drive motors 5 are provided with locating/non-locating bearing arrangements of their drive shaft 7, wherein the individual bearings 12, 13 are designed as ball bearings. These are not suitable for supporting high axial forces. Also the additional bearing 14 is not suitable for supporting high axial forces.

Therefore, in the preferred exemplary embodiment, the drive transmission unit 8 is designed as a gearing that is free of axial forces. The term “free of axial forces” is to be understood such that only forces which are less than 10 N, preferably less than 5 N, in particular less than 2 N, act on the drive shaft 7 via the drive transmission unit 8 in the direction of the axis of rotation 6. The drive transmission unit 8 is a gearing that is free of axial forces both when the work apparatus device 1 is being operated as intended and during a malfunction of the work apparatus device 1. A malfunction is an operation of the work apparatus 1 in which, for example, the chain is blocked by a particularly hard object. In the exemplary embodiment, the drive transmission unit 8 has a transmission ratio of 3. The DC motor provided in the exemplary embodiment has a speed of approximately 20,000 rpm. Due to the transmission ratio of 3, the speed for operating the work apparatus 1 can be reduced.

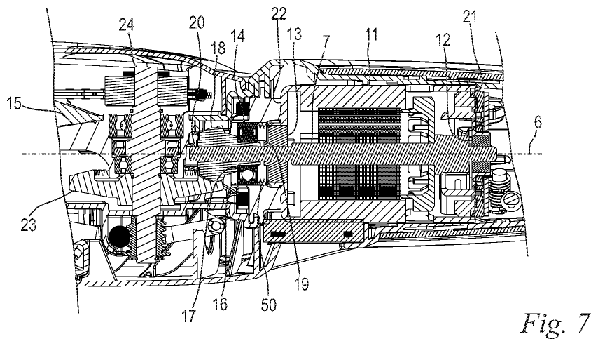

In an alternative embodiment of the work apparatus 1 according to FIG. 7, the work apparatus 1 comprises a spring unit 50. The spring unit 50 is designed such that it pretensions the pinion 18 in the direction of the axis of rotation 6 towards the bevel gear 23. Due to the fact that the pinion 18 and the bevel gear 23 are designed such that no axial forces are transmitted from the bevel gear 23 to the pinion 18, there is an axial play in the drive shaft 7. The variable axial play is overcome by using the spring unit 50. The spring unit 50 is preferably designed as a compression spring. The spring unit 50 is supported on the motor housing 11 and/or on the second bearing 13 of the drive motor 5 and acts on the additional bearing 14. The spring unit 50 pushes the drive shaft 7 with the pinion 18 against the bevel gear 23, whereby the axial play of the drive shaft 7 is overcome. The tolerance of the backlash between the bevel gear 23 and the pinion 18 is reduced, resulting in a longer service life and a reduction in noise emissions from the drive transmission unit 8.

What is claimed is:

1. A portable work apparatus, comprising:
a housing (2), the housing (2) extending from a first end (3) to a second end (4);
a tool (9);
a drive motor (5) arranged in the housing (2) between the first end (3) and the second end (4), the drive motor (5) having
a drive shaft (7) for driving the tool (9),
a first bearing (12), and
a second bearing (13),
wherein the drive shaft (7) is mounted rotatably (11) relative to the housing (2) by means of the first bearing (12) and the second bearing (13);
a drive transmission unit (8), the drive transmission unit (8) being functionally arranged between the drive motor (5) and the tool (9); and
an additional bearing (14) arranged on the drive shaft (7) for supporting the drive shaft (7) relative to the housing (2) of the work apparatus (1).

2. The work apparatus according to claim 1,
wherein the additional bearing (14) is a floating bearing.

3. The work apparatus according to claim 1,
wherein the additional bearing (14) is a ball bearing.

4. The work apparatus according to claim 1,
wherein the drive motor (5) is fastened to the housing (2) in such a way that the drive motor (5) is firmly connected to the housing (2) in a direction of an axis of rotation (6).

5. The work apparatus according to claim 1,
wherein the drive motor (5) is fastened to the housing (2) via an attachment unit (15).

6. The work apparatus according to claim 5,
wherein the additional bearing (14) comprises a bearing outer ring (16) that rests directly on the attachment unit (15).

7. The work apparatus according to claim 1,
wherein the additional bearing (14) includes a bearing inner ring (17) and a bearing outer ring (16), and
wherein a pinion (18) is co-rotatingly held on the drive shaft (7) of the drive motor (5), the pinion (18) being part of the drive transmission unit (8).

8. The work apparatus according to claim 7,
wherein the additional bearing (14) rests with the bearing inner ring (17) on a receiving section (19) of the pinion (18).

9. The work apparatus according to claim 7,
wherein an outer diameter (a) of the bearing outer ring (16) of the additional bearing (14) is at least as large as a maximum outer diameter (d) of the pinion (18).

10. The work apparatus according to claim 7,
wherein the pinion (18) is prestressed in the direction of an axis of rotation (6) of the drive motor (5) by means of a spring unit (50).

11. The work apparatus according to claim 1,
wherein the drive transmission unit (8) is designed as a gearing that is free of axial forces.

12. The work apparatus according to claim 1,
wherein the drive transmission unit (8) has a gear ratio of three.

13. The work apparatus according to claim 1,
wherein the drive motor (5) comprises a motor housing (11),
wherein the drive shaft (7) is rotatably mounted within the motor housing (11) by means of the first bearing (12) and the second bearing (13).
